(19) United States
(12) Patent Application Publication
(10) Pub. No.: US 2019/0226094 A1
(43) Pub. Date: Jul. 25, 2019

(54) PHOSPHOROUS-FREE, AND IRON ACTIVATING AGENT-FREE RUST REMOVAL, INHIBITION, AND PASSIVATION

(71) Applicant: Baker Hughes, a GE company, LLC, Houston, TX (US)

(72) Inventors: Mary Jane Legaspi Felipe, Sugar Land, TX (US); David N. Fulmer, Missouri City, TX (US); Sidney A. Dunn, Lake Charles, LA (US); Jerry J. Weers, Richmond, TX (US); Khac Truc Nguyen, Houston, TX (US); Carl Weaver, Houston, TX (US)

(73) Assignee: Baker Hughes, a GE company, LLC, Houston, TX (US)

(21) Appl. No.: 15/875,854

(22) Filed: Jan. 19, 2018

(51) Int. Cl. C23F 11/04; C11D 7/26; C11D 11/00

(52) U.S. Cl. CPC C23F 11/04; C11D 11/0029; C11D 7/265

(57) ABSTRACT

An additive comprising glucaric acid and/or glucaric acid salt may be added to an aqueous system in an effective amount to remove rust from a corroded metallurgy and inhibit further rust formation and/or corrosion of the metallurgy within the aqueous system, and also to passivate any metallurgy within an aqueous system, wherein the additive may not contain a phosphorous compound or an iron activating agent. The aqueous system may be an aqueous stream, a hydrocarbon stream containing water, a cooling tower, a boiler, a cooling water system, and combinations thereof.

### TECHNICAL FIELD

The present invention relates to methods and additives to simultaneously remove rust from metallurgy that may be found in an aqueous system, to inhibit further rust formation upon and/or corrosion of the metallurgy, and to passivate the metallurgy, without the aid of a phosphorous compound or an iron activating agent.

### BACKGROUND

Rust removal and passivation of metal pipes and equipment employed in aqueous systems and other metallurgy is often a complex, time-consuming process because of the susceptibility of this metallurgy to corrosion and the inconvenient chemical conditions involved.

In addition, there always a concern to better protect metal surfaces that exist within an aqueous system against corrosion in general, such as rusting, as well as pitting corrosion, a specific type of corrosion concentrated in a certain area that forms a pit or divot in the surface of the metal. Corrosion, if unattended, may result in failure or destruction of the metal, causing the particular water system to be shut down until the necessary repairs can be made.

Properly removing, reducing, or preventing rust formation in an aqueous system and improving passivation of metallurgy present in such systems involves a lot of time and must be conducted under very specific conditions, which is costly and often leads to delays in system start-up.

In some instances, hydrochloric acid and surfactants have been employed to remove rust. These maybe effective in the removal of rust but because of the acidic conditions, corrodes the surface easily after rust removal.

Alternatively, oxalic acid has been used in conjunction with phosphorous compounds or an iron-activating agent, such as, ferrous iron, for rust removal. It has been shown that ferrous iron and other types of iron activating agents accelerate the rust removal properties of oxalic acid. In addition, phosphates and other phosphorous compounds are known to aid certain organic acids in inhibiting inhibit rust formation and corrosion. However, the inclusion of these aides creates an added expense and may bring other complications to the systems in which they are used.

Thus, it is desirable to employ more economical, effective rust removal and inhibitor compounds that also can maintain passivation of metallurgy in aqueous systems.

### SUMMARY

There is provided, in one form, a method for removing rust from and inhibiting further rust formation upon and/or corrosion of metallurgy in an aqueous system, the method including introducing in an effective amount of an additive comprising glucaric acid and/or glucaric acid salt to an aqueous system in contact with metallurgy for simultaneously removing rust from the metallurgy and inhibiting further rust formation upon and/or corrosion of the metallurgy in the aqueous system. In one non-limiting embodiment the additive is phosphorous compound-free and iron activating agent-free.

There is also provided a treated aqueous system, wherein the treated aqueous system comprises an aqueous system in contact with metallurgy and an additive comprising glucaric acid and/or glucaric acid salt, the amount of the additive being effective to simultaneously remove rust from and inhibit further rust formation upon and/or corrosion of the metallurgy contacting the aqueous system. Again, in another non-limiting embodiment the treated aqueous system has no added phosphorous compound, and no added iron activating agent,

In other non-limiting embodiments, the additive described in the previous two paragraphs may be used in a method or as part of a treated aqueous system in an effective amount for passivating metallurgy in an aqueous system.

### BRIEF DESCRIPTION OF THE DRAWINGS

FIG. 1 is two photographic illustrations comparing the rust treatment and the passivation of metallurgy in the presence of varying concentrations of the additive disclosed herein;

FIG. 2 is a photographic illustration showing the timeframe for rust removal treatment and/or the passivation of metallurgy in the presence of varying concentrations of the additive disclosed herein and a commercially available inhibited acid cleaning agent; and

FIG. 3 is a photographic illustration comparing the rust treatment of metallurgy using the additive disclosed herein versus using an oxalic acid treatment.

### DETAILED DESCRIPTION

It has been discovered that an additive comprising glucaric acid and/or glucaric acid salt and free of a phosphorous compound and free of an iron activating agent may be added to an aqueous system having metallurgy to more effectively and efficiently remove rust from and simultaneously inhibit further rust formation upon and/or corrosion of the metallurgy It has also been discovered that this additive is useful for improved passivation of metallurgy in an aqueous system.

“Aqueous system” is defined herein to include an aqueous fluid (a fluid containing water) and any components or any metallurgy (e.g. pipes, tanks, conduits, or vessels) through which the aqueous fluid may flow or along or outside of which the aqueous fluid may flow. The aqueous fluid may be or include, but is not limited to, water, brine, seawater, a hydrocarbon stream containing water, and combinations thereof. In one embodiment, the hydrocarbon stream containing water is free of hydrogen sulfide.

In a non-limiting embodiment, the aqueous fluid may circulate through a cooling tower, a cooling water system, an air-conditioning system, boiler, a wastewater treatment system, a deionized water system, and combinations thereof. The cooling tower may be or include an open loop cooling tower, a closed loop cooling tower, and combinations thereof. ‘Open loop’ differs from ‘closed loop’ in that the ‘open loop’ system has recirculating water therethrough.

As used herein, metallurgy is any metal or metal alloy surface that may be corroded. The types of metal surface that may be corroded include, but are not limited to, an iron-containing surface, such as steel; an aluminum-containing surface; yellow metal surfaces, such as copper and copper alloys, and combinations thereof.

The additive may be comprised of glucaric acid and/or glucaric acid salt, and in other non-limiting embodiments, no phosphorous compound, and no iron-activating agent.

Iron-activating agent means any organic or inorganic ferrous containing chemical that is water-soluble. Examples of iron activating agents are, without limitation, ferrous iron, ferrous chloride, ferrous sulfate, ferrous nitrate, ferrous gluconate, ferrous acetate, ferrous tetrafluoroborate, ferrous oxalate, ferrous ammonium sulfate, and combination thereof.

A phosphorus compound could include, without limitation a phosphate, a phosphoric acid, or combinations thereof.

The amount of the additive may range from about 0.01 wt. % independently to about 50 wt. %, based on the total amount of fluid in the aqueous system, alternatively from about 0.05 wt. % independently to about 25 wt. %, based on the total amount of fluid in the aqueous system, or from about 0.1 wt. % independently to about 10 wt. %, based on the total amount of fluid in the aqueous system. As used herein with respect to a range, “independently” means that any threshold may be used together with another threshold to give a suitable alternative range, e.g. a percentage of about 0.05 wt. % to about 50 wt. % is also considered a suitable alternative range.

In one non-limiting embodiment, the additive could further comprise another acid, such as, without limitation, glycolic acid, tartaric acid, mucic acid, hydroxymalonic acid, gluconic acid, ketogluconic acid, citric acid, and combinations thereof. The additive may also comprise the salts of any of these acids or the diastereomers of any of these acids, and combinations thereof.

In another non-limiting embodiment, the aqueous system may contain other compounds such as, but not limited to, a scale dissolver, a biocide, a chlorine-containing component, a surfactant, a corrosion inhibitor, a dispersant, a passivator, and combinations thereof.

A scale dissolver may be used if scales other than iron-based scales are present in the aqueous system. Such scale dissolvers include, but are not limited to, hydrochloric acid, sulfuric acid, and combinations thereof.

Additional corrosion inhibitors may also be included in the aqueous system. Suitable corrosion inhibitors may be, without limitation, hydroxycarboxylic acid, hydroxycarboxylic acid salts, molybdates, zinc, tin, and combinations thereof.

Examples of dispersants useful for dispersing solid debris in the aqueous system include polyacrylates, polymaleates, polycarboxylic acids, their homopolymers, copolymers, terpolymers and combinations thereof.

Other passivators, such as nitrites, polyhydroxycarboxylic acids, polyhydroxycarboxylic acids salts, and combinations thereof may be included in the system during and after cleaning of the metallurgy.

Useful surfactants may be nonionic, cationic, anionic, zwitterionic and combinations thereof.

The biocide may be or include, but is not limited to, sodium hypochlorite (also known as bleach), NaHCIO, chlorine dioxide, chlorine, bromine, non-oxidizing biocides, and combinations thereof. Non-limiting examples of the non-oxidizing biocides may be or include isothiazoline; glutaraldehyde; 2,2-dibromo-3-nitrilopropionamide (DBNPA); and combinations thereof.

The aqueous system is stable in the presence of chlorine-containing components, such as chloride salts. The chlorine-containing components may be optionally present in the aqueous system prior to the addition of the glucaric acid and/or glucaric acid salt additive. Alternatively, the chlorine-containing components may be added to the aqueous system at the same time or different time as the additive disclosed here and be in an amount ranging from about 1 ppm independently to about 1,000 ppm, alternatively from about 50 ppm independently to about 800 ppm, or an amount greater than about 250 ppm in another non-limiting embodiment.

The additive may be used to remove rust from a corroded metallurgy, inhibit further rust formation and/or corrosion of, and passivate the metallurgy in an aqueous system having a wide variety of pH values. The pH of the system may be less than about 7, alternatively from about 3 independently to about 5, or from about 1 independently to about 3 in another non-limiting embodiment. The aqueous system may also have a low pH, such as, without limitation, from about 1.5 independently to about 3 independently.

When used herein, the term “removal” means the removal of any existing rust on metallurgy within an aqueous system.

When used herein, the term “inhibition” means the additive may suppress, reduce, or prevent further rust formation and/or corrosion within the aqueous system. That is, it is not necessary for rust or corrosion to be entirely prevented or removed for the methods or systems discussed herein to be considered effective, although complete removal or prevention is a desirable goal. Success is obtained if less rust formation or corrosion occurs using the additive than in the absence of the additive. Alternatively, the methods and systems described are considered successful if there is at least a 50% decrease in rust formation and/or other corrosion within the aqueous system.

The invention will be further described with respect to the following Examples, which are not meant to limit the invention, but rather to further illustrate the various embodiments.

### EXAMPLES

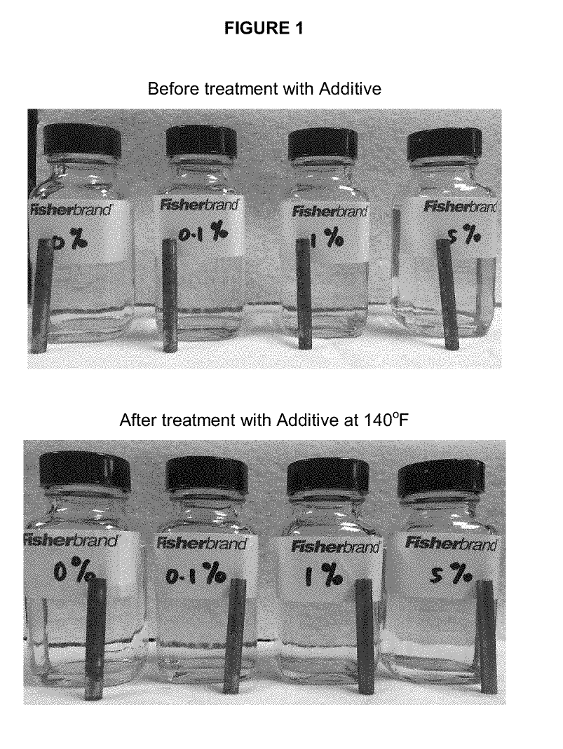

FIG. 1 is two photographic illustrations comparing the rust treatment and the passivation of metallurgy in the presence of varying concentrations of glucaric acid-based additive.

The top row of photographs shows the pieces of metallurgy prior to the glucaric acid-based additive being applied.

The second row of photographs shows the same pieces of metallurgy after treatment with the glucaric acid-based additive with varying amounts of the additive at a temperature of 140° F. (60° C.).

These photos show that the glucaric acid additive was effective in reducing or removing rust from the metallurgy at concentrations of 0.1° A and 5%.

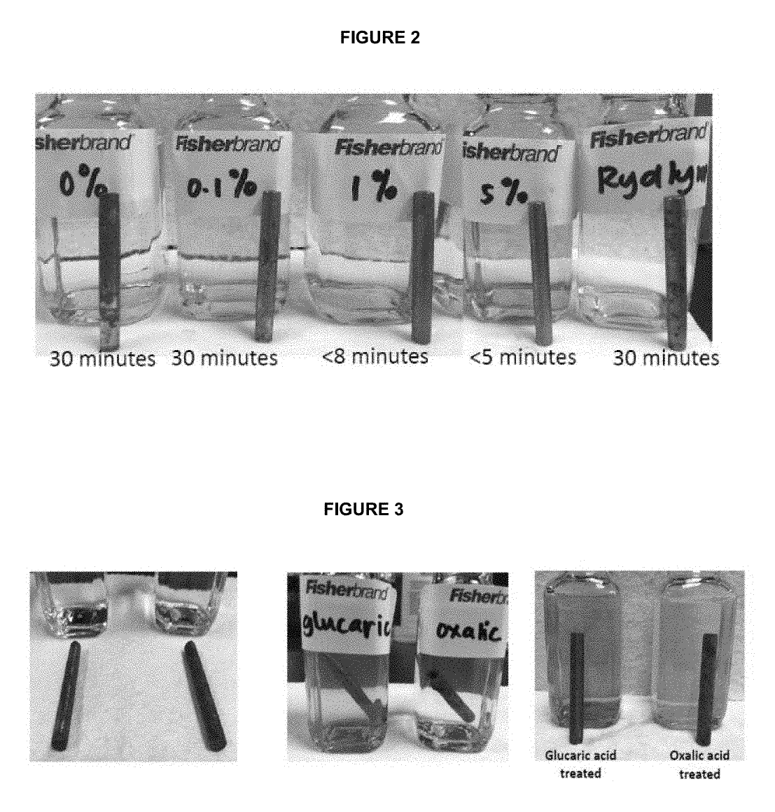

FIG. 2 is a photographic illustration showing the timeframe for rust treatment and/or the passivation of metallurgy in the presence of varying concentrations of a glucaric acid-based additive and a commercially available inhibited acid cleaning agent.

In FIG. 2, the pieces of metallurgy that were treated with 1° A and 5% of the glucaric acid and/or glucaric acid salt additive demonstrated better and quicker rust removal and passivation than those pieces of metallurgy treated with less of the same additive and significantly better rust removal and passivation than a piece of metallurgy treated with a commercially available inhibited acid cleaning agent.

FIG. 3 is a photographic illustration comparing the rust treatment of metallurgy using the additive disclosed herein versus using an oxalic acid treatment.

The photographs in FIG. 3 demonstrate that the glucaric acid-based treatment was significantly more effective in simultaneously removing or reducing rust/corrosion and in passivating of the metal pieces than the oxalic acid additive treatment.

In the foregoing specification, the invention has been described with reference to specific embodiments thereof. However, it will be evident that various modifications and changes can be made thereto without departing from the broader spirit or scope of the invention as set forth in the appended claims. Accordingly, the specification is to be regarded in an illustrative rather than a restrictive sense. For example, aqueous systems, metallurgy, equipment, specific aqueous fluids, acids, salts of acids, diastereomers of acids, components, scale dissolvers, surfactants, corrosion inhibitors, dispersants, passivators, biocides, and chlorine-containing components falling within the claimed parameters, but not specifically identified or described in a particular embodiment, are expected to be within the scope of this invention.

The present invention may suitably comprise, consist or consist essentially of the elements disclosed and may be practiced in the absence of an element not disclosed.

For example, the methods may consist of or consist essentially of adding glucaric acid in an effective amount to passivate a metallurgy or to inhibit rust or corrosion of the metallurgy in an aqueous system without the aid of a phosphorous compound and an iron activating agent. Alternatively, the additive may consist essentially of or consist of glucaric acid alone or together with any optional components that do not materially affect the basic and novel characteristics of the invention claimed.

In another non-restrictive version, a treated aqueous system may consist essentially of or consist of an aqueous system in contact with metallurgy and glucaric acid, and no phosphorous compound and no iron activating agent, wherein the amount of the additive being effective to inhibit rust formation and/or corrosion or to passivate metallurgy within the aqueous system. Alternatively, additive may consist essentially of or consist of glucaric acid alone or together with any optional components that do not materially affect the basic and novel characteristics of the invention claimed.

As used herein, the terms “comprising,” “including,” “containing,” “characterized by,” and grammatical equivalents thereof are inclusive or open-ended terms that do not exclude additional, unrecited elements or method acts, but also include the more restrictive terms “consisting of” and “consisting essentially of” and grammatical equivalents thereof. As used herein, the term “may” with respect to a material, structure, feature or method act indicates that such is contemplated for use in implementation of an embodiment of the disclosure and such term is used in preference to the more restrictive term “is” so as to avoid any implication that other, compatible materials, structures, features and methods usable in combination therewith should or must be, excluded.

As used herein, the singular forms “a,” “an,” and “the” are intended to include the plural forms as well, unless the context clearly indicates otherwise.

As used herein, the term “and/or” includes any and all combinations of one or more of the associated listed items.

As used herein, the term “about” in reference to a given parameter is inclusive of the stated value and has the meaning dictated by the context (e.g., it includes the degree of error associated with measurement of the given parameter).

What is claimed is:

1. A method for removing rust from and inhibiting further rust formation and/or corrosion upon metallurgy in an aqueous system comprising: introducing an additive comprising glucaric acid and/or a glucaric acid salt to
an aqueous system in contact with metallurgy, the amount of the
additive being effective to remove rust from and inhibit rust formation
and/or corrosion of the metallurgy within the aqueous system;
simultaneously removing rust from the metallurgy and inhibiting further rust formation and/or corrosion of the metallurgy.

2. The method of claim 1 in the absence of adding a phosphorous compound.

3. The method of claim 1 in the absence of adding an iron-activating agent.

4. The method of claim 1, wherein the additive further comprises an acid selected from the group consisting of glycolic acid, tartaric acid, mucic acid, hydroxymalonic acid, gluconic acid, ketogluconic acid, citric acid, salts of any of these acids, diastereomers of any of these acids, and combinations thereof.

5. The method of claim 1, wherein the effective amount of the additive ranges from about 0.01 wt. % to 50 wt. % based on a total amount of fluid in the aqueous system.

6. The method of claim 1, wherein the aqueous system is selected from the group consisting of an aqueous stream, a hydrocarbon stream containing water, a cooling tower, a cooling water system, and combinations thereof.

7. The method of claim 1, wherein the aqueous system further comprises at least one additional component selected from the group consisting of a scale dissolver, a biocide, a chlorine-containing component, a surfactant, a corrosion inhibitor, a dispersant, a passivator, and combinations thereof.

8. The method of claim 4 wherein the aqueous system further comprises at least one additional component selected from the group consisting of a scale dissolver, a biocide, a chlorine-containing component, a surfactant, a corrosion inhibitor, a dispersant, a passivator, and combinations thereof.

10. The method of claim 1, wherein the aqueous system has a pH from about 1.5 to about 3.

11. A treated aqueous system comprising:
an aqueous system in contact with metallurgy; and
an additive comprising glucaric acid and/or glucaric acid salt, the amount of the additive being effective to remove rust from the metallurgy and inhibit further rust formation and/or corrosion of the metallurgy contacting the aqueous system.

12. The treated aqueous system of claim 11 in the absence of an added phosphorous compound.

13. The treated aqueous system of claim 11 in the absence of an added iron-activating agent.

14. The treated aqueous system of claim 11, wherein the additive further comprises an acid selected from the group consisting of glycolic acid, tartaric acid, mucic acid, hydroxymalonic acid, gluconic acid, ketogluconic acid, citric acid, salts of any of these acids, diastereomers of any of these acids, and combinations thereof.

15. The treated aqueous system of claim 11, wherein the effective amount of the additive ranges from about 0.01% to 50% based on a total amount of fluid in the aqueous system.

16. The treated aqueous system of claim 11, wherein the aqueous system is selected from the group consisting of an aqueous stream, a hydrocarbon stream containing water, a cooling tower, a cooling water system, and combinations thereof.

17. The treated aqueous system of claim 11, wherein the aqueous system further comprises at least one additional component selected from the group consisting of a scale dissolver, a biocide, a chlorine-containing component, a surfactant, a corrosion inhibitor, a dispersant, a passivator, and combinations thereof.

18. The treated aqueous system of claim 17, wherein the scale dissolver is selected from the group consisting of hydrochloric acid, sulfuric acid, and combinations thereof.

19. The treated aqueous system of claim 11, wherein the aqueous system comprises a stream that is free of hydrogen sulfide.

20. A method for passivating metallurgy in an aqueous system comprising:
introducing an additive comprising glucaric acid and/or glucaric acid salt to the aqueous system, the amount of the additive being effective to passivate metallurgy within the aqueous system;
passivating the metallurgy without the addition of a phosphorous compound and an iron-activating agent.
